(19) United States
(12) Patent Application Publication
(10) Pub. No.: US 2002/0077099 A1
(43) Pub. Date: Jun. 20, 2002

(54) Method and system for providing satellite communications

(75) Inventor: James Nicholas LaPrade, Pleasanton, CA (US)

Correspondence Address: Joyce E. Kosinski, 655 Loral Space and Communications, Ltd., Deep Valley Drive, Suite 303, Rolling Hills Estates, CA, 90274, US

(73) Assignee: Space Systems/Loral, Inc.

(21) Appl. No.: 09/739,942

(22) Filed: Dec. 18, 2000

(51) Int. Cl. H04Q 7/20

(52) U.S. Cl. 455/430; 455/12.1; 455/427

(57) ABSTRACT

A broad-band digital satellite communications system for providing broad-band data services. The system comprises a first spacecraft, generally a geo-stationary earth orbit communications device, and at least one controller having broadband communications capability with the first spacecraft. The system also includes at least one second spacecraft, generally a low earth orbit (LEO) communications device. The second spacecraft comprises ; communications capability with the at least one first spacecraft; low data rate communications capability with a land based system, generally a mobile communications service provider; and broadband communications capability with a mobile user subscriber to the mobile communications service provider.

### BACKGROUND OF THE INVENTION

1. Field of the Invention

The present invention relates to satellite communications systems and, more particularly, to providing asymmetric data services.

2. Prior Art

A number of user applications continue to drive the requirement for high speed data services. Some industry specific examples include remote film editing, medical image transport, financial service data consolidation and backup and Internet communications. As business, government and educational institutions disseminate more information, greater importance is attached to data transfer. In this environment, reliable, high speed data services becomes even more critical. In addition, growth in Internet traffic has caused a strain on the capacity of telephony networks. Network shortcomings include network outages, insufficient access bandwidth, insufficient inter-node bandwidth, and poor spectral efficiency. Providers are required to make significant investments, as well as experience installation delays, to upgrade network infrastructure.

Corporate LANs/WANs also generate an demand for higher bandwidth. The demand for bandwidth goes up as more and more users are connected. The users, in turn, demand more services and improved network speed. Personal computers are being used to process not only text, but graphics and video as well, all on networks that are increasingly global. High speed networking is also driven by the growth of video distribution, client/server technology, decentralized systems, increased processing power and developments in storage capacity.

While existing satellite systems offer global service, they do not offer direct connection to the end user at moderate to high data rates. Many of the existing fixed satellite service systems employ wide channel bandwidths and relatively large beam-widths making them more suited to point-to-point trunking service rather than to end user connectivity. The wide area coverage, and constrained flexibility of these systems renders these systems both inefficient and costly to serve many small or isolated users.

For example U.S. Pat. No. 5,906,337 addresses continuous unbroken links between a geo-stationary and a medium earth orbit satellite with a relationship between orbits that provides continuous contacts. However, the reference does not disclose or suggest exploiting asymmetry data rates for efficient communications.

U.S. Pat. No. 5,448,623 addresses a single LEO constellation without a coupling to a GEO satellite system and without reference to the asymmetric data flow or directing traffic flow from the ground based upon the position information given by the network control from the satellite data.

U.S. Pat. No. 5,887,257 is directed to provisions of control signals for channel assignment between various satellites. There is no disclosure or suggestion pertaining to provision of control signals from ground through a first (GEO) to second (LEO) for the purpose of directing a beam (channel) based on a priori position knowledge gained from user of system. Nor does the reference disclose or suggest inter-satellite links between satellites in the two different constellations.

U.S. Pat. No. 5,890,679 relates only to medium earth orbit satellite constellations of specific configurations. There is no disclosure or suggest pertaining to the provision of broadband data via a geo-stationary earth orbit satellite-to-low earth orbit satellite path that is under ground network operations control.

U.S. Pat. No. 5,896,558 is directed to all bi-directional links LEO-to-GEO/GEO-to-LEO that involve onboard processor traffic switching. There is no disclosure or suggestion pertaining to asymmetric broadband data provision via one-way link from GEO-to-LEO for broadband data.

U.S. Pat. No. 5,907,541 addresses a cellular extension satellite systems but not broadband data system and not using GEO+LEO (but only GEO+GEO). No exploitation of data traffic asymmetry is disclosed or suggested.

U.S. Pat. No. 5,930,254 relates to fast packet switching onboard a satellite without efficiently addressing channel assignments with ground-based data processing and controls distributed to all LEO satellites in view of a GEO.

U.S. Pat. No. 5,987,233 addresses data caching in a global satellite system but does not disclose or suggest the efficient exploitation of asymmetric data traffic, GEO+LEO, ground based channel assignments with spatial division multiplexing, or anything beyond simply broadcasting and caching of data services.

U.S. Pat. No. 5,722,042 is directed towards signals that go through high altitude satellites for large terminals and low altitude satellites for small terminals so it is a combination of LEO or GEO but not both, thereby failing to efficiently exploit asymmetric data rates.

U.S. Pat. No. 4,985,706 is for the simultaneously up-linked signals on a common frequency that do not interfere because pseudo random spreading is used on one up-link to de-couple the power level from the second up-link. There is no suggestion of providing efficient data services via satellite communications.

U.S. Pat. No. 6,011,951 regards the sharing of frequencies using directional antennas to various satellite constellations. The reference does not address the efficient asymmetric GEO+LEO broadband data service provision through gateway channel SDMA assignment of variously comprised TDMA and CDMA traffic and control signals.

U.S. Pat. No. 6,002,916 relates to server architecture and does not disclose or suggest an efficient communications system by exploiting asymmetric data traffic with an asymmetric broadband GEO+LEO system. In addition, the referenced systems require onboard processing.

U.S. Pat. No. 5,995,497 relates to switching of CDMA traffic channels (beams) but does not disclose or suggest efficient communications to ground based stations.

U.S. Pat. No. 6,016,124 is directed towards base-band digital beam-forming but does not disclose or suggest efficient communications to ground based stations.

U.S. Pat. No. 5,790,070 regards the steering of beams and methodology to do the same using the satellite as the network node. But the reference does not disclose or suggest an efficient communications system by exploiting asymmetric data traffic with an asymmetric broadband GEO+LEO system.

The emerging cellular type satellite services serve a very large number of potential subscribers but only at very low data rates. The on-board processing and packet-switched nature of their signal structure severely limits the practical user data rates that can be accommodated within the technology limitations of the processor. Thus, there exists a need for a satellite communications system that serves the demand for high data rate users.

Moreover, the frequency transmission spectrum is finite resulting in the requirement that the spectrum be used in the most efficient manner. Thus, there exists a need for a satellite communications system that serves the demand for high data rate users and efficiently utilizes the frequency transmission spectrum.

### SUMMARY OF THE INVENTION

A broad-band digital satellite communications system for providing data services is provided. The system comprises a first spacecraft, a controller having broadband communications capability with the first spacecraft, and a second spacecraft. The second spacecraft, having a lower orbit than the first spacecraft, comprises communications capability with the at least one first spacecraft, low data rate communications capability with at least one first land based system, and broadband communications capability with at least one second land based system.

A method for providing asymmetric broadband data services to mobile users is also provided. The method comprises the steps of receiving broadband data at a ground station; transmitting the broadband data on an up-link channel (or channels) from the ground station to a geo-stationary earth orbit satellite. The broadband data received on the up-link channel or channels is combined to form a replica of the broadband data received at the ground station. The replicated broadband data is then retransmitted to a satellite constellation comprised of at least one low earth orbit (LEO) satellite. Each LEO satellite within the constellation has at least one controllable spot beam and each controllable spot beam has at least one down-link communications channel. The method determines if the replicated broadband data exceeds available down-link communications channel capacity associated with the available down-link communication channel(s); and increases the number of available down-link communication channels accordingly if the replicated broadband data exceeds available down-link communication channel capacity. The next method step parses the replicated broadband data on to the number of available down-link communication channels and transmits the replicated broadband data on the number of available down-link communication channels to at least one mobile user.

A broad-band digital satellite communications system for providing asymmetric broadband data services to mobile users is also provided. The system comprises a geo-synchronous earth orbit (GEO) satellite; a data traffic gateway (DTG) having broadband communications capability with the GEO satellite; a network controller connectable to the at least one DTG; and at least one low earth orbit (LEO) satellite. The LEO satellite comprises communications capability with DTG; communications capability with the at least one GEO satellite; low data rate communications capability with at least one land based system; and broadband communications capability with a mobile user.

A method for maximizing spectral efficiency in a satellite communications system having a first satellite constellation disposed at a orbit higher than a second satellite constellation is also provided. The first satellite constellation having communications capability with a network controller and the second satellite constellation. The method comprises the steps of allocating the total up-link resources available from the network controller to up-link data to the first satellite constellation. The up-linked data is broadcasted substantially simultaneously from the first satellite constellation to the second satellite constellation. Spot communication beams associated with the second satellite constellation transmit a predetermined fraction of the up-linked data to mobile users.

A communications system for providing internet data services between a user and an internet is also provided. The system comprises a satellite constellation and a ground station having communications capability with the satellite constellation and the user. The system also comprises a second ground station having communications capability with the satellite constellation and the internet.

A method for providing internet data services between at least one user and an internet is also provided. The method comprises the steps of transmitting data from the at least one user to a satellite constellation and assigning the data to at least one communications channel within the satellite constellation. The method also comprises the steps of steering at least one satellite spot communication beam associated with the communication channel(s) to illuminate the geographical position of the internet and parallel transmitting data to the internet.

### BRIEF DESCRIPTION OF THE DRAWINGS

The foregoing aspects and other features of the present invention are explained in the following description, taken in connection with the accompanying drawings, wherein:

FIG. 1 is a pictorial schematic of data flow from a land-based system to a mobile user incorporating features of the present invention;

FIG. 2 is a pictorial schematic of data flow from a land-based system to a mobile user incorporating overlapping beam features of the present invention shown in FIG. 1; and

FIG. 3 is a method flow chart for using the systems shown in FIGS. 1 or 2 to transmit data from a ground station to a mobile user;

FIG. 4 is an alternate method flow chart for using the systems shown in FIGS. 1 or 2 to transmit data from a ground station to a mobile user;

FIG. 5 is a pictorial diagram of a communications system incorporating features of the present invention; and

FIG. 6 is a method flow chart for using the system shown in FIG. 5.

### DETAILED DESCRIPTION OF THE PREFERRED EMBODIMENT

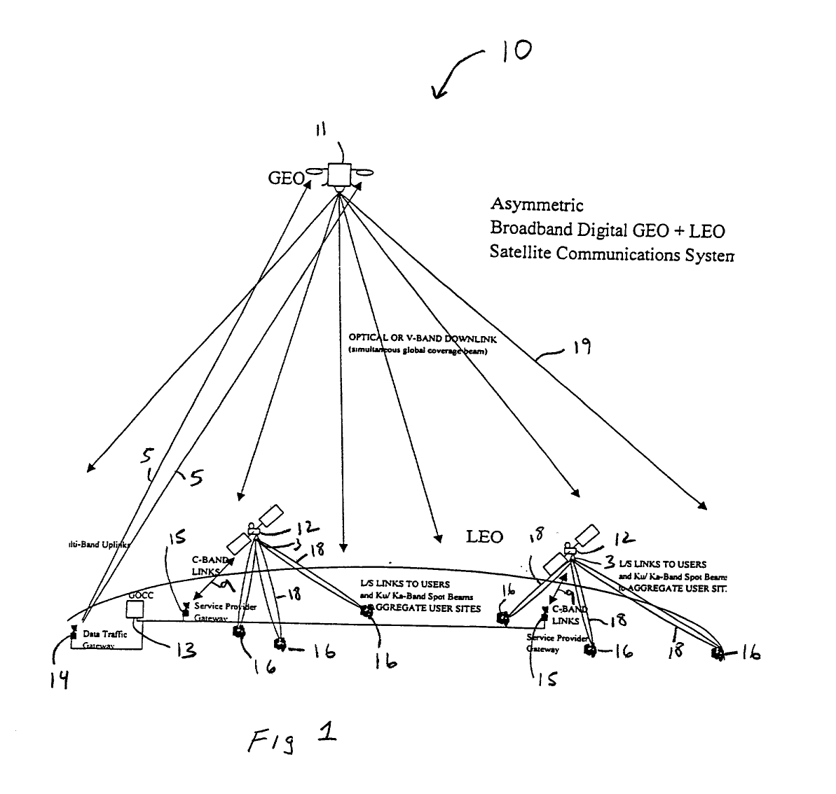

Referring to FIG. 1, there is shown a pictorial representation of a system 10 for providing data services to mobile users and incorporating features of the present invention. Advantageously this system exploits the natural asymmetry between low rate requests for data and the high rate data requested. First, through the use of the user return links that issue data requests, such as a session on the internet where large downloads are requested, and then through the application of user position information already present within the system via low rate communications links 9 between the user 16 and the LEO satellite 12. Furthermore, the gateway operations and control center (GOCC) 13 controls low data rate, such as cellular service operations, and provides data services such as broadband data services. User position information is derived from the low data rate service to make appropriate data channel and beam assignments and to initialize and update the beam pointing algorithms that control the phased-array antennas 3 onboard the LEO satellites 12. The Data Traffic Gateway (DTG) 14 is provided to centralize the interface to the service provider backbone and provide up-link communications with the geo-stationary earth orbit (GEO) satellite. Addition of the DTG 14 links it to the GOCC and the service provider gateways. It is appreciated that providing appropriate LEO satellites 12 data channel and beam assignments from the GOCC 13 to the DTG 14 to the GEO 11 satellite and then to the LEO satellite 12 constellation obviates the requirement for line-of-sight LEO satellite control centers.

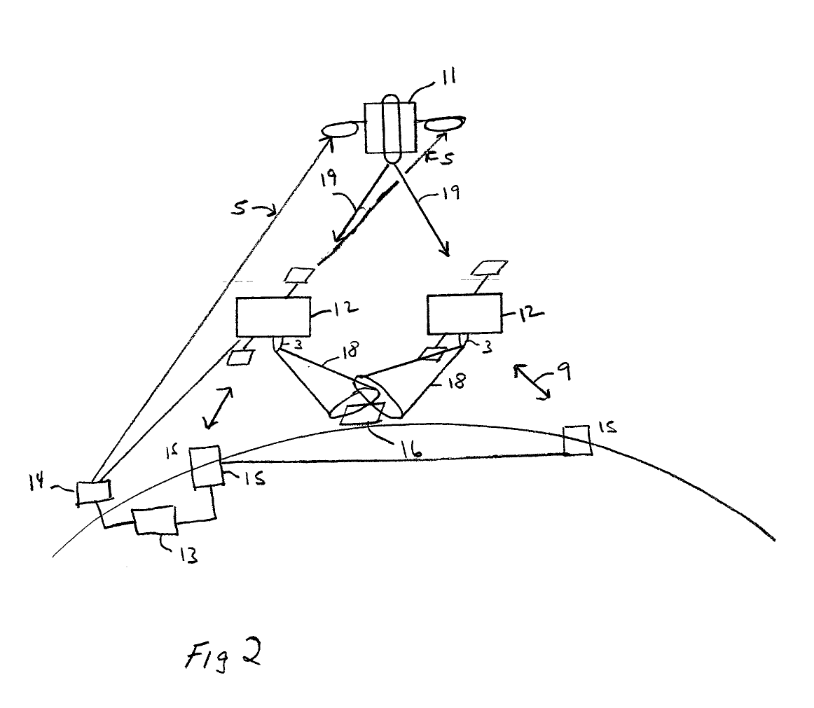

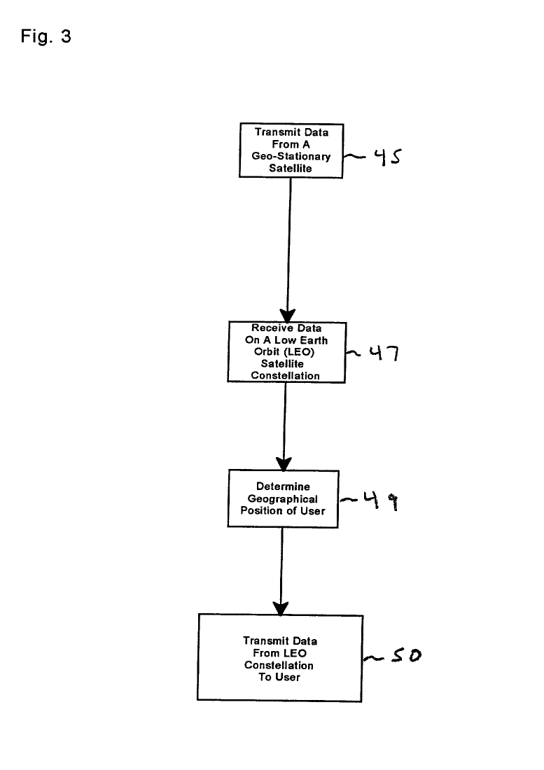

Referring to FIG. 3 there is shown a method flow chart for using the system shown in FIGS. 1 or 2 to transmit data from a ground station to a mobile user. Data is transmitted from a geo-stationary satellite (GEO) (FIG. 1, item 11) and received 47 on a low earth orbit (LEO) satellite constellation (FIG. 1, items 12), where a satellite constellation may be one or more LEO satellites. A geographical position of a user requesting the data is determined 49 and the data is transmitted 50 from the LEO (FIG. 1, items 12) constellation to the user (FIG. 1, item 16).

Referring now to FIG. 1, digital signals are transmitted from the DTG 14 to a geo-stationary (GEO) 11 satellite within multiple Fixed Satellite space-to-Earth frequency bandwidth allocations on multi-band up-link channels 5. These signals are combined onto a signal that is transmitted from the GEO 11 satellite to a satellite constellation of low earth orbit (LEO) satellites 12. A subset of the satellites 12 in the LEO constellation are simultaneously illuminated by the GEO satellite 11. Each LEO satellite 12 transmits multiple, independently directed spot beams 18, each providing a predetermined fraction of the digital signal traffic received from the GEO-LEO inter-satellite link 19. The fraction of the digital signal may be determined by channel allocation requirements, spot beam overlap, and/or channel transmission environment. Each LEO phased-array antenna 3 independently points separate beams 18 to user terminals 16 tracked by the position information available from user voice/data low rate links 9 between the service provider gateway 15 and the LEO satellite 12. Broadband data requests are processed through the interactive voice/data low rate links 9 that comprise a LEO constellation based cellular telephone system. Broadband data are transmitted to users from the data traffic gateway 14 through the GEO spacecraft 11 and then to the user terminal 15 through one or more of the LEO satellites 12 within view of the user terminal 16. Thus, the system maintains a low data rate return link from each user through the conventional cellular telephone extension function and distributes high rate data as might be requested from an internet service provider through the spot beams. LEO satellite traffic and beam assignments and their associated tracking trajectories and traffic hand-offs are managed through the central Gateway Operations and Control Center (GOCC) 13 and the local service provider gateways 15. The digital up-links to the GEO satellite are also managed from the GOCC 13. Multiple GEO satellites and data traffic gateways are used to achieve global broadband coverage.

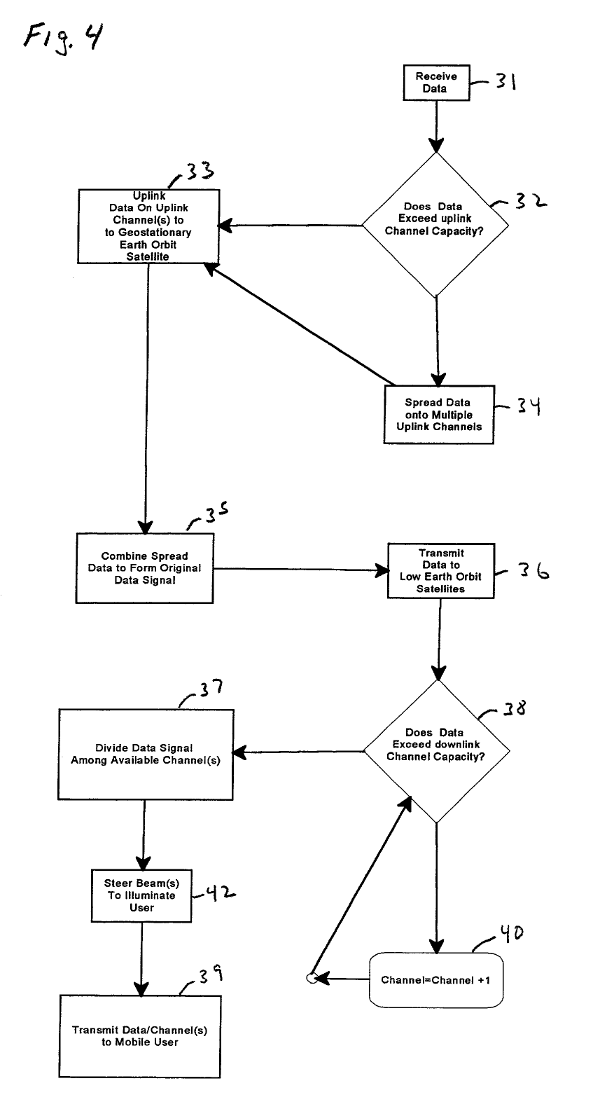

Referring now to FIG. 4 there is shown a method flow chart for using the systems shown in FIGS. 1 or 2 to transmit data from a ground station to a mobile user. FIGS. 1 and 4 and the following numerical example illustrate features of the present invention. Select for this example frequency division multiplexed (FDM) signals with a center band spacing of 57.14 MHz, guard bands between channels of 7.14 MHz and no guard bands at the edges of the up-link and down-link bands. Identify 4.8 GHz of up-link bandwidth for the Earth-to-GEO data link that uses dual-polarization techniques to transmit 84 channels, nominally 50 MHz each, within the 27.5-to-29.9 GHz Region 2 FCC allocation for Earth-to-space communications. Data is received 31 at the data traffic gateway 14 and evaluated 32 for required up-link channel capacity. If available channel capacity is exceeded the data is parsed 34 on to multiple up-link channels before the date is substantially parallel up-linked 33 to the GEO satellite 11. Receivers on board the GEO satellite 11 translate 35 the FDM signals into the 59-64 GHz band allocated for inter-satellite communications. All 84 channels are substantially simultaneously broadcasted 36 on a single polarization into an earth coverage beam that includes, for example, the 1414 km altitude of the GLOBALSTAR satellites. Receivers on each of the LEO satellites 12 translate the FDM channels from the inter-satellite link into the 400 MHz band of 19.7-to-20.1 GHz that is allocated for mobile satellite space-to-earth communications. The next step determines 38 if the data exceeds available down-link channel capacity. This step may be predetermined at the GOCC 13 or the GEO 11 from known channel capacity and data down-link requirements. In addition, the channel down-link capacity may be dynamically determined 38 by one or more of the LEO satellites. If the channel capacity is exceeded more channels are added 40. For example, there are at least, 12 beams on a GLOBALSTAR LEO satellite that can be independently formed within the active phased-array antenna. With general regard to communications beam forming reference can be had to “Digital Beamforming in Wireless Communications”, by John Litva and Titus KwokYeung Lo, ISBN 0-89006-712-0, the disclosure of which is incorporated by reference in its entirety.

Each beam may contain up to 7 channels from the inter-satellite link. Each beam is independently pointed to a user within the spot beam coverage. In addition, since a LEO satellite within the LEO constellation has a view of +/−54 degrees to all earth terminals with at least a 10 degree elevation angle view of the satellite, many more than 12 spot beams with coverage areas of about 2 degrees may be simultaneously pointed to deliver high rate data to multiple locations without generating significant interference between beams. Thus, if the total channel capacity of an individual satellite within the LEO constellation is exceeded then channels from a satellite with overlapping beam coverage are allocated to carry a fraction of the data signal (FIG. 2, item 18). The next step 42 steers the beams associated with the allocated channels to illuminate the user. The last step spreads 37 the data onto the allocated channels to be transmitted 39 to the user.

It is readily appreciated from this example that space division multiplexing (SDM) using a multi-beam phased-array antenna can provide many times frequency reuse. In this manner, all allocated up-link and down-link bandwidth with high data rate signals through the translation of the multi-band FDM traffic onto a single optical carrier signal for the GEO-to-LEO inter-satellite link are advantageously utilized. Multi-spot-beam phased-array antennas customized for each allocated down-link band may then be used to fold the many up-link channels into the many down-link beams, by utilizing a beams set for each of the various down-link bands.

It is readily appreciated that the efficiency of spectral resource allocation comes from the mapping of subsets or fractions of the up-link spectrum onto spot beams; effectively using some or all of a particular bandwidth allocated for space-to-Earth communications.

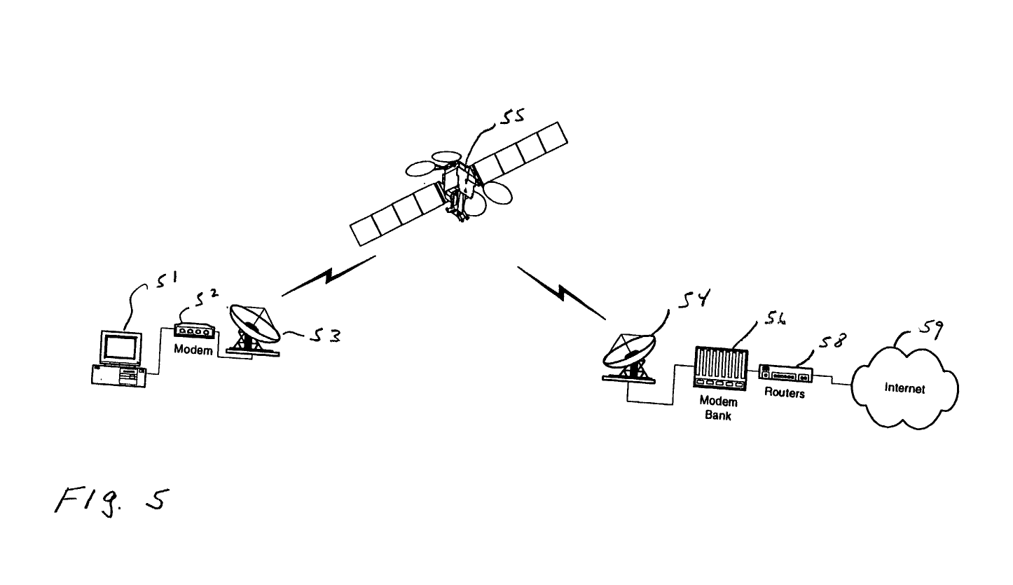

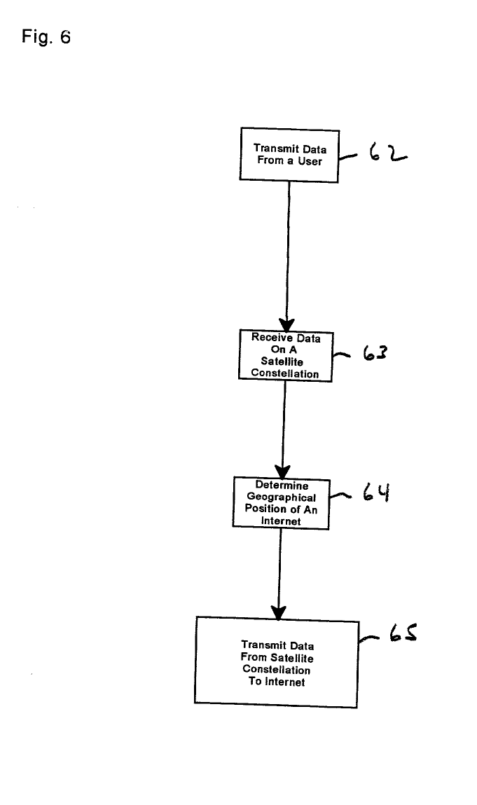

Referring now to FIG. 5 there is shown a pictorial diagram of another communications system incorporating features of the present invention. Referring also to FIG. 6 there is shown a method flow chart for using the system shown in FIG. 5. Terminal 51 transmit data 62 to a satellite constellation 55 through modem 52 and ground station 53. The data is received 63 on the satellite constellation 55, where the satellite constellation may comprise one or more satellites. The geographical position of an internet 59 is determined 64 and the data is transmitted 65 to the internet through ground station 54, modem bank 56, and routers 58.

It is readily appreciated that features of the present invention allow rurally located users, or other users where internet connection is not economically feasible, to have access to internet services. In addition, it is also readily appreciated that the internet access is not limited to narrow-band data services but includes broadband services as well.

Lastly, it should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A broad-band digital satellite communications system for providing data services , the system comprising:
at least one first spacecraft;
at least one controller having broadband communications capability with the at least one first spacecraft;
at least one second spacecraft having a lower earth orbit than the at least one first spacecraft, the at least one second spacecraft comprising:
communications capability with the at least one first spacecraft;
low data rate communications capability with at least one first land based system; and
broadband communications capability with at least one second land based system.

2. A broad-band digital satellite communications system as in claim 1 wherein the at least one first spacecraft comprises at least one high earth orbit satellite.

3. A broad-band digital satellite communications system as in claim 2 wherein the at least one high earth orbit satellite comprises at least one geo-stationary earth orbit satellite.

4. A broad-band digital satellite communications system as in claim 1 wherein the at least one second spacecraft comprises at least one low earth orbit satellite.

5. A broad-band digital satellite communications system as in claim 1 wherein the at least one second spacecraft further comprises at least one independent communications beam-former.

6. A broad-band digital satellite communications system as in claim 5 wherein the at least one independent communications beam-former comprises at least one communications data channel.

7. A broad-band digital satellite communications system as in claim 1 wherein the at least one second spacecraft further comprises low data rate time division multiple access (TDMA) communications capability with the at least one first land based system.

8. A broad-band digital satellite communications system as in claim 1 wherein the at least one second spacecraft further comprises low data rate code division multiple access (CDMA) communications capability with the at least one first land based system.

9. A broad-band digital satellite communications system as in claim 1 wherein the at least one second spacecraft further comprises code division multiple access (CDMA) broadband communications capability with the at least one second land based system.

10. A broad-band digital satellite communications system as in claim 1 wherein the at least one second spacecraft further comprises time division multiple access (TDMA) broadband communications capability with the at least one second land based system.

11. A broad-band digital satellite communications system as in claim 1 wherein the broad-band satellite communications system further comprises encryption/decryption capability.

12. A method for providing asymmetric broadband data services to a mobile user, the method comprising the steps of:
transmitting data from at least one geo-stationary earth orbit (GEO) satellite, the step of transmitting data from the GEO satellite comprises the steps of:
transmitting data from the GEO satellite to at least one low earth orbit (LEO) satellite constellation, the LEO satellite constellation comprising a plurality of LEO satellites;
determining the geographical position of the mobile user; and
transmitting the data to the mobile user.

13. A method as in claim 12 wherein the step of transmitting data from at least one geo-stationary earth orbit (GEO) satellite further comprises the steps of:
receiving broadband data on at least one second base station;
transmitting the broadband data on at least one up-link channel from the at least one second base station;
receiving the broadband data transmitted on the at least one up-link channel at the GEO satellite; and
combining the broadband data received on the at least one up-link channel to form a replica of broadband data received at the ground station.

14. A method as in claim 13 wherein the step of receiving broadband data at the at least one second base station further comprises the steps of:
determining if the received broadband data exceeds up-link communication channel capacity; and
adding up-link communication channels based on the determination the received broadband data exceeds up-link communication channel capacity.

15. A method as in claim 12 wherein the step of transmitting the data to the mobile user further comprises the steps of:
determining if the data exceeds available down-link communications channel capacity associated with the at least one down-link communication channel;
increasing the number of available down-link communication channels based on the determination that the data exceeds available down-link communication channel capacity;
parsing the data on to the number of available down-link communication channels; and
transmitting the data on the number of available down-link communication channels to the at least one mobile user.

16. A method as in claim 15 wherein the step of increasing the number of available down-link communication channels based on the determination that the data exceeds available down-link communication channel capacity further comprises the steps of:
determining the number of available independent spot beams;
determining the number of available communication channels for each available independent spot beam;
calculating total down-link communication channel capacity available based on the determination of the number of available communication channels;
determining a total down-link communication channel capacity required to transmit the replicated broadband data;
comparing the total down-link communication channel capacity available with the total down-link communication channel capacity required to transmit the replicated broadband data; and
increasing the number of available independent spot beams if the comparison of the total down-link communication channel capacity available with the total down-link communication channel capacity required to transmit the replicated broadband data indicates more communication channel capacity is required.

17. A method as in claim 16 wherein the step of increasing the number of available independent spot beams further comprises the step of assigning additional independent spot beams from additional satellites within the LEO constellation.

18. A method as in claim 15 wherein the step of transmitting the data on the number of available down-link communication channels to the at least one mobile user further comprises the steps of:
determining a geographical position of the mobile user;
identifying the controllable spot beams associated with the down-link communication channels required to transmit the data to the geographical position of the mobile user;
steering the identified controllable spot beams to illuminate the geographical position of the mobile user; and
transmitting the data on the identified down-link communication channels.

19. A method as in claim 18 wherein the step of steering the identified controllable spot beams to illuminate the position of the mobile user further comprises the step of steering the identified controllable spot beams emanating from a plurality of LEO satellites.

20. A method as in claim 12 wherein the step of determining the geographical position of the mobile user further comprises the steps of:
exchanging low data rate communications between the LEO satellite and at least one mobile base station; and
determining from the exchanged low data rate communications the geographical position of the at least one mobile user.

21. A method as in claim 20 wherein the step of exchanging low data rate communications with the at least one mobile base station further comprises the step of exchanging low data rate communications with a land-based mobile base station.

22. A method as in claim 12 wherein the step of determining the geographical position of the mobile user further comprises the steps of:
transmitting the mobile user's global positioning satellite (GPS) coordinates to at least one second base station; and
determining the mobile users position from the GPS coordinates.

23. A broad-band digital satellite communications system for providing asymmetric broad-band data services to a mobile user, the system comprising:
at least one geo-synchronous earth orbit (GEO) satellite;
at least one data traffic gateway (DTG) having broad-band communications capability with the at least one GEO satellite;
at least one controller connectable to the at least one DTG;
at least one low earth orbit (LEO) satellite, the at least one LEO satellite comprising:
communications capability with the at least one DTG;
communications capability with the at least one GEO satellite;
low data rate communications capability with at least one land based system; and
broad-band communications capability the mobile user.

24. A broad-band digital satellite communications system as in claim 23 wherein the at least one DTG (DTG) further comprises at least one communications channel with the GEO satellite.

25. A broad-band digital satellite communications system as in claim 23 wherein the at least one LEO broadband communications capability further comprises at least one controllable communications beam-former, each communications beam-former having at least one communications channel.

26. A method for maximizing spectral efficiency in a satellite communications system having at least one first satellite constellation disposed at a orbit higher than at least one second satellite constellation, and at least one network controller having communications capability with the at least one first satellite constellation, the method comprising the steps of:
allocating the total up-link resources available from the network controller to up-link data to the at least one first satellite constellation;
broadcasting substantially simultaneously the up-linked data from the at least one first satellite constellation to the at least one second satellite constellation; and
assigning spot communication beams associated with the at least one second satellite constellation to transmit a predetermined fraction of the up-linked data.

27. A method as in claim 26 wherein the step of allocating the total up-link resources available from the network controller to up-link data to the at least one first satellite constellation further comprises the steps of:
determining if the data exceeds up-link communication channel capacity;
allocating up-link communication channels based on the determination the data exceeds up-link communication channel capacity;
assigning a unique fraction of the data to each allocated up-link communication channel; and
parallel transmitting the unique fractions of data on each allocated up-link channel from the network controller to the at least one first satellite constellation.

28. A method as in claim 26 wherein the step of broadcasting substantially simultaneously the up-linked data from the at least one first satellite constellation to the at least one second satellite constellation further comprises the step of broadcasting substantially simultaneously the up-linked data from at least one geo-stationary earth orbit (GEO) satellite to at least one low earth orbit (LEO) satellite constellation.

29. A method as in claim 26 wherein the step of assigning spot communication beams associated with the at least one second satellite constellation to transmit a predetermined fraction of the up-linked data further comprises the steps of:
determining a geographical position of a mobile user;
identifying the spot communication beams, associated with the second satellite constellation, required to transmit the data to the geographical position of the mobile user;
steering the identified spot communication beams to illuminate the geographical position of the mobile user; and
transmitting the data on down-link communication channels associated with the identified spot communication beams.

30. A method as in claim 29 wherein the step of determining the geographical position of the mobile user further comprises the steps of:
exchanging low data rate communications between the at least one second satellite constellation and at least one mobile base station; and
determining from the exchanged low data rate communications the geographical position of the at least one mobile user.

31. A method as in claim 29 wherein the step of determining the geographical position of the mobile user further comprises the steps of:
transmitting the mobile user's global positioning satellite (GPS) coordinates to the at least one network controller; and
determining the mobile users position from the GPS coordinates.

32. A method as in claim 29 wherein the step of determining the geographical position of the mobile user further comprises the steps of:
transmitting the mobile user's latitude/longitude (lat/long) coordinates to the at least one network controller; and
determining the mobile users position from the lat/long coordinates.

33. A communications system for providing internet data services between a user and an internet, the system comprising:
at least one satellite constellation;
at least one first ground station having communications capability with the at least one satellite constellation and the user; and
at least one second ground station having communications capability with the at least one satellite constellation and the internet.

34. A communications system as in claim 33 wherein the communications system further comprises a digital communications system.

35. A communications system as in claim 33 wherein the at least one satellite constellation further comprises a plurality of multi-orbit satellites.

36. A communications system as in claim 33 wherein the at least on satellite constellation further comprises at least one satellite.

37. A communications system as in claim 36 wherein the at least one satellite further comprises at least one steerable spot beam.

38. A communications system as in claim 37 wherein the at least one steerable spot beam further comprises at least one communications channel.

39. A communications system as in claim 33 wherein the at least one first ground station having communications capability with the at least one satellite constellation and the user further comprises the first ground station having multiple communications channels with the at least one satellite constellation.

40. A communications system as in claim 33 wherein the at least one second ground station having communications capability with the at least one satellite constellation further comprises the second ground station having multiple communications channels with the at least one satellite constellation.

41. A method for providing internet data services between at least one first user and an internet, the method comprising the steps:
transmitting data from the at least one first user to a satellite constellation;
assigning the data to at least one communications channel within the satellite constellation;
steering at least one satellite spot communication beam associated with the at least one communications channel to illuminate the internet; and
parallel transmitting data to the internet.

42. A method as in claim 41 wherein the step of transmitting data from the at least one first user to a satellite constellation further comprises the steps of:
transmitting the data to a first ground station;
determining if the data exceeds the ground station's up-link communication channel capacity;
allocating up-link communication channels based on the determination the data exceeds up-link communication channel capacity until up-link channel capacity meets or exceeds the amount of data to be transmitted;
assigning a unique fraction of the data to each allocated up-link communication channel; and
parallel transmitting the unique fractions of data on each allocated up-link channel from the first ground station to the satellite constellation.

43. A method as in claim 41 wherein the step of assigning the data to at least one communications channel within the satellite constellation further comprises the step of identifying the at least one satellite spot communication beam, associated with the second satellite constellation, required to illuminate the internet.

44. A method as in claim 43 wherein the step identifying the at least one satellite spot communication beam required to illuminate the internet further comprises the steps of:
determining a geographical position of the internet;
identifying the at least one satellite spot communication beam, associated with the second satellite constellation, required to transmit the data to the geographical position of the internet;
steering the identified at least one satellite spot communication beam to illuminate the geographical position of internet; and
parallel transmitting the data on down-link communication channels associated with the identified at least one satellite spot communication beam.
